(19) United States
(12) Patent Application Publication
(10) Pub. No.: US 2007/0218776 A1
(43) Pub. Date: Sep. 20, 2007

(54) Fuel supply line connector for water heater mounting bracket

(75) Inventors: Michael A. Garrabrant, Unicoi, TN (US); Roger D. Veen, Johnson City, TN (US)

Correspondence Address: IP GROUP OF DLA PIPER US LLP, ONE LIBERTY PLACE, 1650 MARKET ST, SUITE 4900, PHILADELPHIA, PA, 19103, US

(73) Assignee: American Water Heater Company, a corporation of The State of Nevade, Atlanta, GA (US)

(21) Appl. No.: 11/725,285

(22) Filed: Mar. 19, 2007

Related U.S. Application Data
(60) Provisional application No. 60/783,966, filed on Mar. 20, 2006.
(60) Provisional application No. 60/784,142, filed on Mar. 20, 2006.

(51) Int. Cl. H01R 13/514

(52) U.S. Cl. 439/701

(57) ABSTRACT

An assembly for a water heater combustion chamber access door including a bracket having a plurality of leg members, each leg member having a distal portion sized and shaped to connect to the door and a proximal portion connected to a hub member having an opening with a slot; and a fuel supply line connector having a tab adapted to engage the slot and another tab adapted to engage the hub member.

### CROSS-REFERENCE TO RELATED APPLICATIONS

This patent application claims the benefit of U.S. Provisional Application Nos. 60/783,966, filed Mar. 20, 2006, and 60/784,142, filed Mar. 20, 2006. These earlier provisional applications are hereby incorporated by reference.

### TECHNICAL FIELD

The technology in this disclosure relates to a fuel line connector, particularly to a fuel line connector adapted to connect a fuel supply line to the door covering the combustion chamber of a water heater.

### BACKGROUND

Water heater manufacturers have sought to construct fuel-efficient and low emission water heaters in an economical manner for many years. One way in assisting fuel efficiency of the water heater is to position the fuel supply in a way that better mixes the fuel with intake air. An example of assisting in increasing the economics of constructing the water heater is to facilitate easier and better assembly, especially of the outer jacket relative to other components of the water heater.

### SUMMARY

We provide an assembly for a water heater combustion chamber access door including a bracket having at least one leg member, the at least one leg member having a distal portion sized and shaped to connect to the door and a proximal portion connected to a hub member having an opening with a receiving portion; and a fuel supply line connector having a connector portion adapted to engage the receiving portion and another connector portion adapted to engage the hub member.

We also provide a water heater combustion chamber access door assembly including a door sized and shaped to at least partially cover an opening in a water heater combustion chamber; a bracket connected to the door including at least one leg member, the at least one leg member having a distal portion connected to the door and a proximal portion connected to a hub member having an opening with a receiving portion; and a fuel supply line connector having a connector portion adapted to engage the receiving portion and another connector portion adapted to engage the hub member.

We further provide a water heater including a water container; a combustion chamber having an opening located adjacent the water container; a burner associated with the combustion chamber; a door having an opening and being sized and shaped to at least partly cover the combustion chamber opening; a bracket connected to the door including at least one leg member, the at least one leg member having a distal portion connected to the door and a proximal portion connected to a hub member having an opening with a receiving portion; a fuel supply line connector having a connector portion sized and shaped to engage the receiving portion and another connector portion adapted to engage the hub member; and a fuel supply line connected to the connector.

We still further provide a water heater assembly including a door having an opening and being sized and shaped to at least partly cover an opening in a water heater combustion chamber; a bracket connected to the door and having a base member with an opening having a receiving portion and positioned in substantial alignment with the door opening and at least one leg extending between the base member and the door; and a fuel supply line connector having a connector portion sized and shaped to engage the receiving portion and another connector portion adapted to engage the base member.

We further yet provide a low NO_{X} water heater including a water container, a combustion chamber adjacent the water container, a burner associated with the combustion chamber and arranged to combust fuel to heat water in the water container, the burner having a combustion surface and a fuel/air conduit extending from the plenum and adapted to receive fuel, and a fuel nozzle positioned to supply fuel into the fuel/air conduit at an angle that is between about 1.5° and about 2.5° out of horizontal relative to a horizontal plane extending along a central axis of the fuel/air conduit.

### BRIEF DESCRIPTION OF THE DRAWINGS

FIG. 1 is a partial cross-sectional view of a water heater.

FIG. 2 is a perspective view of a fuel supply line with a connector.

FIG. 3 is a perspective view of a fuel supply line and an orifice member, broken away from each other for ease of understanding.

FIG. 4 is a schematic perspective view of a fuel orifice member.

FIG. 5 is a perspective view of a mounting bracket mounted onto a water heater combustion chamber door which is connected to a burner.

FIG. 6 is a perspective view of the fuel supply line and connector of FIG. 2 and the mounting bracket of FIG. 5.

FIG. 7 shows the fuel supply line, connector and mounting bracket of FIG. 5 connected together.

FIG. 8 is a schematic side elevational view of a burner, venturi and fuel nozzle.

### DETAILED DESCRIPTION

It will be appreciated that the following description is intended to refer to specific embodiments of structure selected for illustration in the drawings and is not intended to define or limit the content of this disclosure, other than in the appended claims.

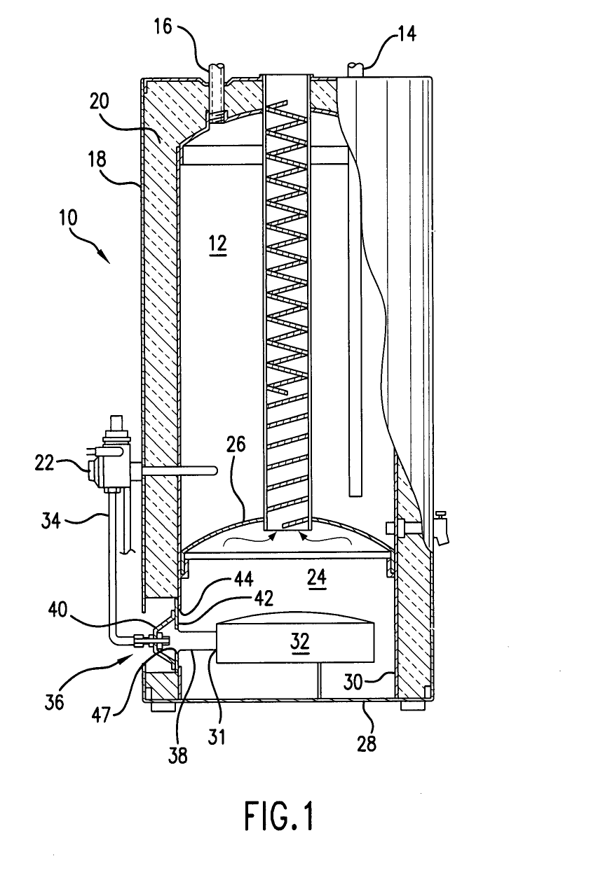

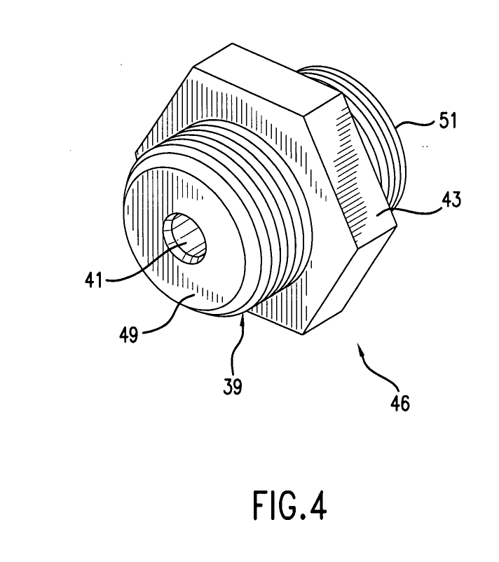

Turning to the drawings in general and FIGS. 1-5 in particular, a water heater 10, including a water tank 12, a water inlet 14, a water outlet 16, an outer jacket 18 and foam insulation 20 is shown. A gas valve 22 is mounted to the side of water heater 10 and receives fuel from a fuel supply (not shown). A combustion chamber 24 is formed below water tank 12 and bounded by water tank bottom 26, bottom pan 28 and skirt 30. Combustion chamber 24 contains a burner 32.

Fuel flows from gas valve 22 to fuel supply line 34, through connector 36 and through venturi 38 into burner 32. Connector 36 is held into a fixed position by mounting bracket 40. Mounting bracket 40 connects to door 42, which covers opening 44 in skirt 30. Venturi 38 connects between an opening 31 in burner 32 and an opening 47 in door 42.

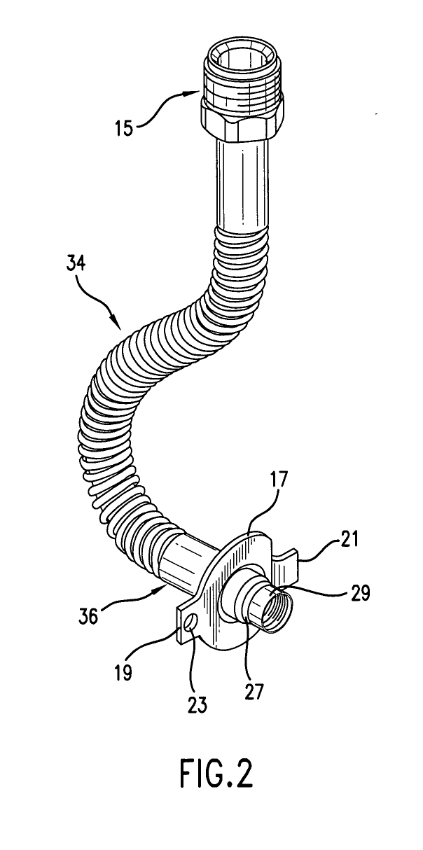

Referring more specifically to FIGS. 2-5, fuel supply line 34 has a threaded connector 15 that connects to gas valve 22 on one end and, as mentioned above, connector 36 on the opposed end. Connector 36 has a flange 17 having opposed connector portions 19 and 21. Connector portions 19 and 21, sometimes referred to as “connector” and/or “another connector” and also as “tabs,” which can be in various shapes, sizes, orientations and configurations so long as they are operative to work in conjunction with the receiving portions described below. Tab/another connector 19 has an opening 23 which is located, sized and shaped to substantially align with hole 56 in flattened base member 52. Introduction of a fastener such as a screw, clip, pin, toggle lock or the like through opening 23 and hole 56 removably fixes connector 36 to mounting bracket 40. Similarly, tab/connector 21 is positioned, shaped and sized to engage a receiving portion slot 25 of central opening 54 in bracket 40. Receiving portion 54 will be referred to as “slot,” and can be in various sizes, shapes, orientations and configurations so long as it is operative to work in conjunction with the connector portions described above. This helps maintain alignment of fuel nozzle or orifice 46 with respect to venturi 38 as discussed in detail below.

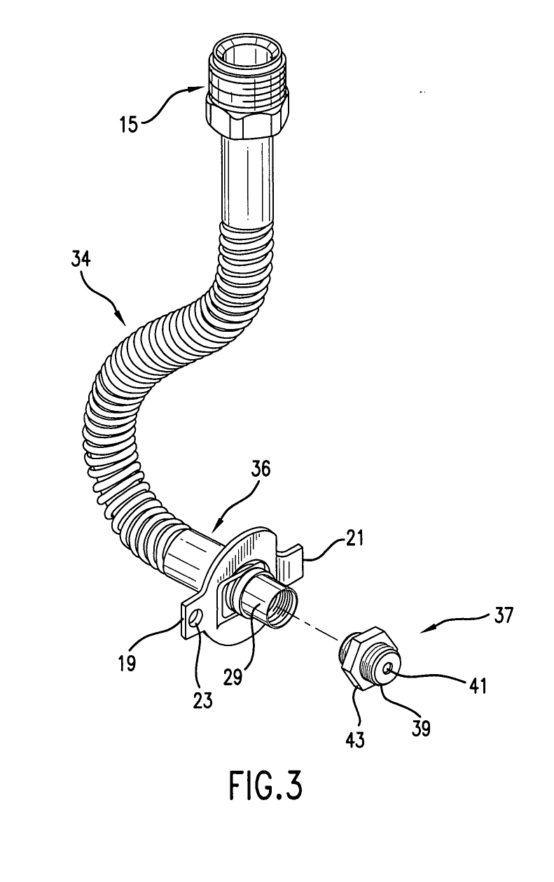

Connector 36 extends through flange 17 on its distal-most end portion 29. The interior surface of end portion 29 is threaded so that it can threadingly engage a fuel nozzle or orifice 46. As shown in FIG. 3, fuel nozzle or orifice 46 has a threaded cylindrically shaped body 39 with a central bore 41 extending through the length of body 39. A flange 43 facilitates connection to connector 36.

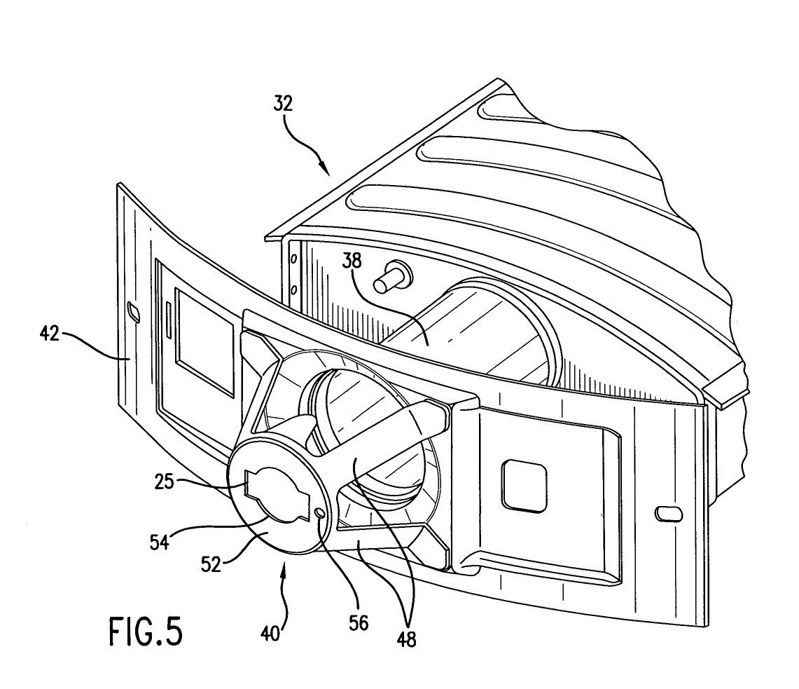

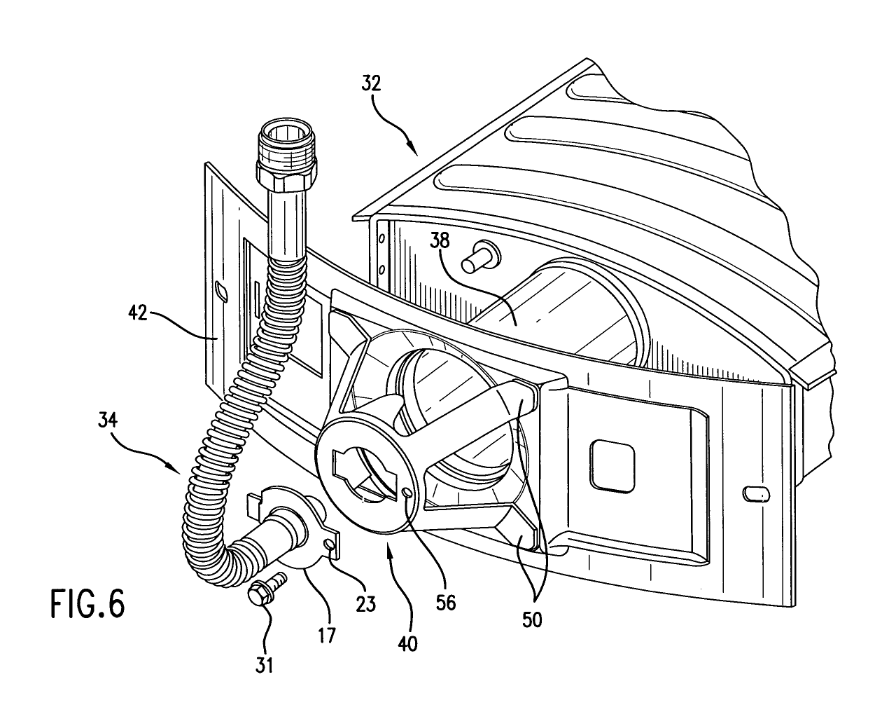

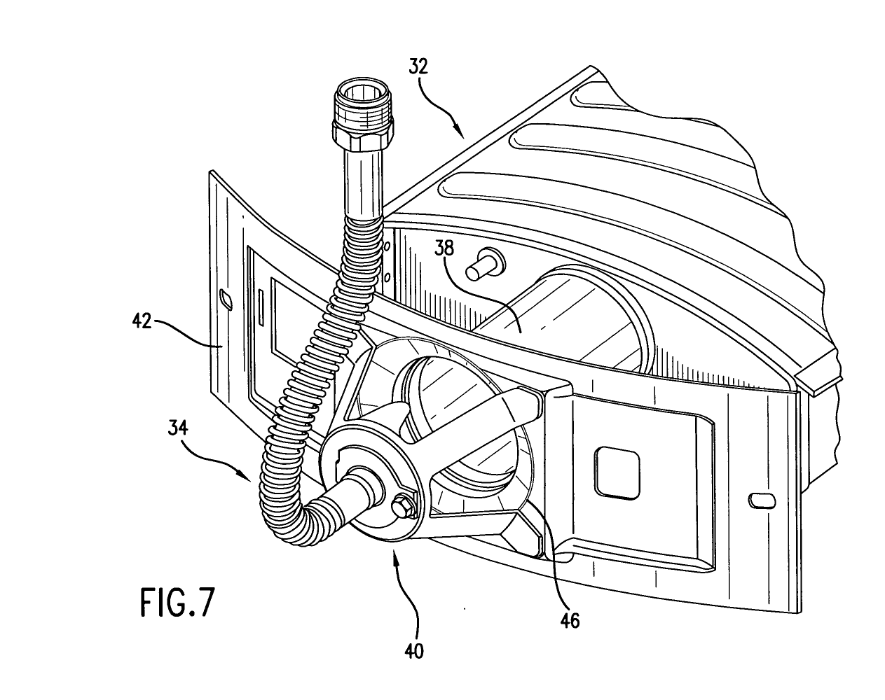

Referring more specifically to FIGS. 5-7, mounting bracket 40 comprises four legs 48. Each leg 48 has a tab 50 to connect to door 42. This can be done in any number of ways, such as with a hole through which a screw, toggle lock or the like or by welding, brazing or the like, for example. Each leg 48 connects to a flattened base member 52 that has a central opening 54. Central opening 54 is sized and shaped to receive connector 36. Flattened base member 52 also has a hole 56 to receive a screw 31 on connector 36.

The legs 48 are mounted to door 42 such that they are at an angle or, said differently, not perpendicular to door 42. Also, the legs are at an angle or are not parallel to an axis extending along venturi 38. There is no particular angle that is critical, although an angle of about 20 to about 90 degrees from the central axis running through venturi 38 is preferred. It is also possible that legs 48 are formed at different angles, preferably with the angles of legs 48 that are mounted to the upper portion of door 42 having the greater angle to facilitate assembly of outer jacket 18 with respect to bottom pan 28. Such different angles can be accommodated by altering the size and/or shape of base member 52 or by altering the length and shape of the proximal portions of selected ones of the legs 48.

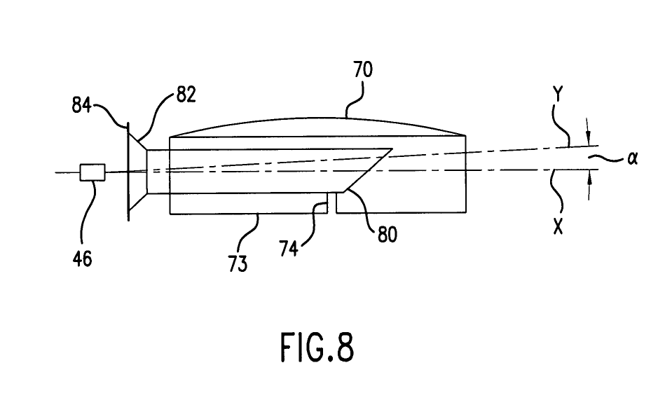

Also, referring to FIG. 8 in conjunction with FIGS. 1 and 3, a schematic representation of nozzle 46 is shown. Nozzle 46 has a central bore 41 extending from an inlet side 49 to an outlet side 51. Threads allow fuel nozzle 46 to be sealingly fixed to connector 36. FIG. 8 particularly shows a dashed axis “X” that extends longitudinally through venturi 38 as a center axis. A dashed line “Y” is angled out of horizontal from axis “X” at angle α. Angle α should be between about 1.50 and about 2.50, preferably about 2°. Dashed line “Y” forms the angle at which a central axis extending through nozzle 46 should be tilted out of horizontal to further enhance complete combustion of fuel emanating from nozzle 46 to further reduce NO_{X} emissions. Although we are not entirely sure of the mechanism behind this phenomenon and do not wish to be bound by any particular theory, we discovered that the normal horizontal introduction of fuel into venturi 38 does not produce the same combustion completion efficiency as does the about 1.5° -about 2.50 out of horizontal range. We also discovered that increasing the angle beyond the above-specified range to as much as about 3% results in degradation of combustion efficiency back to the horizontal levels.

The construction of mounting bracket 40 and its connection to door 42 stabilizes the fuel introduction point with respect to incoming combustion air to facilitate better mixing to enhance combustion efficiency and/or reduce emissions. The generally frusto conical shape of bracket 40 provides a stable structure for the exit point of the fuel to facilitate accurate dispensing of the fuel. Also, the frusto conical shape may facilitate manufacturing by virtue of assisting jacket 18, when being lowered over tank 12 and insulation 20, to continue downward vertical movement toward pan 26 without being impeded. When the lowering action of jacket 18 is not achieved substantially completely vertically, the lower edge of outer jacket 18 can impact on the upper legs 48 of mounting bracket 40. This frequently occurs on the assembly line. The “sloped” or “angled” orientation of the upper ones of legs 48 assists in aligning jacket 18 into a proper position for connection to bottom pan 26.

Also, the rectangular opening in the outer jacket 18 for access to the combustion chamber door/burner does not extend all the way to the bottom of jacket 18. Instead, there is typically about a one-inch strip of metal remaining on the bottom of jacket 18 so that the jacket does not twist and distort during assembly. As noted above, the “sloped” or “angled” orientation of the upper ones of legs 48 assists in allowing that one-inch strip of metal to move downwardly past the external components of the burner assembly and into the bottom pan of the water heater.

This construction also facilitates installation of the burner assembly into the combustion chamber. It is typically easier and more efficient to install the burner into the combustion chamber prior to placement of the combustion chamber onto a moving assembly line. However, in prior bracket designs, the bracket tended to extend too far radially outwardly, which necessitated installation of the burner into the combustion chamber on the assembly line, which is difficult and inefficient.

In a different but related way, the orifice mounting arrangement on the hub allows the assembler to install the fuel supply line/connector/orifice assembly into the bracket at the bottom of the combustion chamber while the water heater is on the moving assembly line after outer jacket 18 is installed with a simple fastener such as a screw. The advantage is that the other side is self-aligning and locked.

Although mounting bracket 40 is shown having four legs, it is possible for there to be more or fewer legs 48. The actual number of legs 48 is not critical, so long as mounting bracket 40 is mounted to door 42 to take advantage of the “sloping” affect.

Although this disclosure has been described in connection with specific forms thereof, it will be appreciated that a wide variety of equivalents may be substituted for the specified elements described herein without departing from the spirit and scope of the content of this disclosure as described in the appended claims.

Examples of substitutable components of the water heater include various types of gas control valves 22, whether mechanical, electromechanical or electronic. Various types of burners 32 may be used such as pan burners of the infrared/screen type or other types of burners. Many types of foam insulation may be used in connection with various types of water heaters. Also, the combustion chamber 22 can contain any number of components such as radiation shields, sensors, thermocouples, pilot burners, pilot fuel supply lines and the like.

Similarly, mounting bracket 40 can be constructed of any number of materials, although steel type materials are preferred. Various numbers of legs 48 may be employed, either in conjunction with flattened plate 52 or without flattened plate 52. In other words, the respective legs 48 can merely intersect one another to form an intersection having a central opening of the type shown with central opening 54 that is sufficiently sized and shaped to receive an orifice holder. Further, various types of connecting means may be employed to permanently or removably connect mounting bracket 40 to door 42. Toggle locks and screws are preferred. Although two embodiments of orifice holders have been shown, others may be utilized. It is also preferred to have the connector 58 tapered to further assist in alignment of the bottom edge of jacket 18 to facilitate easy fitting of jacket 18 over the mounting bracket and into engagement with bottom pan 26.

It is also possible that leg members 48 can have a variety of shapes and sizes to accommodate particular needs. Also, the spaces between the legs can be completely open or partially closed with a type of screen material to prevent the ingress of rodents or other small animals.

What is claimed is:

1. An assembly for a water heater combustion chamber access door comprising:
a bracket having at least one leg member, the at least one leg member having a distal portion sized and shaped to connect to the door and a proximal portion connected to a hub member having an opening with a receiving portion; and
a fuel supply line connector having a connector portion adapted to engage the receiving portion and another connector portion adapted to engage the hub member.

2. The assembly of claim 1, wherein the bracket comprises four leg members.

3. The assembly of claim 1, wherein the leg member extends away from the hub member at an angle not perpendicular to the hub member.

4. The assembly of claim 1, wherein the fuel supply line connector has an inlet portion adapted to sealingly engage a fuel supply line and an outlet portion opening toward an opening in the access door.

5. The assembly of claim 1, wherein the hub member has a second opening and the another connector portion has an opening that aligns with the second opening when the connector portion and the receiving portion are engaged such that the fuel supply line connector may be fixed to the bracket with a fastener.

6. The assembly of claim 5, wherein the fastener is a screw.

7. The assembly of claim 1, wherein the receiving portion is a slot.

8. The assembly of claim 1, wherein the connector portion is a tab.

9. The assembly of claim 1, wherein the another connector portion is a tab.

10. A water heater combustion chamber access door assembly comprising:
a door sized and shaped to at least partially cover an opening in a water heater combustion chamber;
a bracket connected to the door comprising at least one leg member, the at least one leg member having a distal portion connected to the door and a proximal portion connected to a hub member having an opening with a receiving portion; and
a fuel supply line connector having a connector portion adapted to engage the receiving portion and another connector portion adapted to engage the hub member.

11. The assembly of claim 10, wherein the hub member has a second opening and the another connector portion has an opening that aligns with the second opening when the connector portion and the receiving portion are engaged such that the fuel supply line connector may be fixed to the bracket with a fastener.

12. The assembly of claim 10, wherein the fastener is a screw.

13. The assembly of claim 10, wherein the connector portion is a tab.

14. The assembly of claim 10, wherein the another connector portion is a tab.

15. A water heater comprising:
a water container;
a combustion chamber having an opening located adjacent the water container;
a burner associated with the combustion chamber;
a door having an opening and being sized and shaped to at least partly cover the combustion chamber opening;
a bracket connected to the door comprising at least one leg member, the at least one leg member having a distal portion connected to the door and a proximal portion connected to a hub member having an opening with a receiving portion;
a fuel supply line connector having a connector portion sized and shaped to engage the receiving portion and another connector portion adapted to engage the hub member; and
a fuel supply line connected to the connector.

16. The water heater of claim 15, wherein the at least one leg member extends away from the hub member at an angle not perpendicular to the hub member.

17. The water heater of claim 16, wherein the hub member has a second opening and the another connector portion has an opening that aligns with the second opening when the connector portion and the receiving portion are engaged such that the fuel supply connector connector may be fixed to the bracket with a fastener.

18. A water heater assembly comprising:
a door having an opening and being sized and shaped to at least partly cover an opening in a water heater combustion chamber; and
a bracket connected to the door and having a base member with an opening having a receiving portion and positioned in substantial alignment with the door opening and at least one leg extending between the base member and the door; and
a fuel supply line connector having a connector portion sized and shaped to engage the receiving portion and another connector portion adapted to engage the base member.

19. The assembly of claim 18, wherein the bracket comprises four leg members.

20. The assembly of claim 18, wherein the at least one leg member extends away from the hub member at an angle not perpendicular to the hub member.

21. The assembly of claim 18, wherein the fuel supply line connector has an inlet portion adapted to sealingly engage a fuel supply line and an outlet portion opening toward an opening in the access door.

22. The assembly of claim 18, wherein the hub member has a second opening and the another connector portion has an opening that aligns with the second opening when the connector portion and the receiving portion are engaged such that the connector may be fixed to the bracket with a fastener.

23. The assembly of claim 18, wherein the fastener is a screw.

24. The assembly of claim 18, wherein the receiving portion is a slot.

25. The assembly of claim 18, wherein the connector portion is a tab.

26. The assembly of claim 18, wherein the another connector portion is a tab.

27. A low NO_{X} water heater comprising:
a water container;
a combustion chamber adjacent the water container;
a burner associated with the combustion chamber and arranged to combust fuel to heat water in the water container, the burner having a combustion surface and a fuel/air conduit extending from the plenum and adapted to receive fuel; and
a fuel nozzle positioned to supply fuel into the fuel/air conduit at an angle that is between about 1.5° and about 2.5° out of horizontal relative to a horizontal plane extending along a central axis of the fuel/air conduit.

28. The water heater defined in claim 27, wherein the angle is about 2°.

29. The water heater defined in claim 27, further comprising a fuel supply line connector having a connector portion, a receiving portion of a bracket and another connector portion adapted to engage the bracket.

30. The water heater defined in claim 29, wherein the hub member has a second opening and the another connector portion has an opening that aligns with the second opening when the connector portion and the receiving portion are engaged such that the fuel supply line connector may be fixed to the bracket with a fastener.

31. The water heater defined in claim 29, wherein the receiving portion is a slot.

32. The water heater defined in claim 29, wherein the connector portion is a tab.

33. The water heater defined in claim 29, wherein the another connector portion is a tab.
